(19) United States
(12) Patent Application Publication
(10) Pub. No.: US 2005/0108413 A1
(43) Pub. Date: May 19, 2005

(54) Personal digital radio network

(76) Inventor: Matthew Melmon, San Diego, CA (US)

Correspondence Address: Fernandez & Associates, LLP, PO Box D, Menlo Park, CA, 94026-6402, US

(21) Appl. No.: 10/700,880

(22) Filed: Nov. 3, 2003

(51) Int. Cl. G06F 15/16

(52) U.S. Cl. 709/231; 709/236

(57) ABSTRACT

Server sends digital content to a docking station such as a computer or kiosk. Docking station separates digital content into header and body components and associates unique identifiers with each. Portable device downloads header and body components and unique identifiers from docking station for playback. Portable device requests identifier pair from server, assembles identified components into digital content file and plays content for user.

### BACKGROUND

1. Field

Invention relates to portable devices, and in particular to using a server to deliver content to portable devices.

2. Related Art

Conventionally, the broadcast of digital media content has been the domain of radio or television broadcasting. While efficient in delivering content to a large number of listeners (or viewers), conventional broadcasting lacks interactivity, personalization of content delivery, immediate measurement of audience preferences, and one-to-one marketing capabilities. The mass audiences built by terrestrial broadcasters demonstrate the commercial appeal of their carefully selected content offerings. Current Internet services offer consumers ample interactivity, but at a cost of choice management. It is too much work for consumers to explore every piece of content offered by every content producer. That is the job of the broadcaster. The present invention proposes to leverage the content expertise of broadcasters while providing interactivity in an environment that compensates relevant rights holders for use of their material.

### SUMMARY

Present invention describes a Personal Digital Radio Network (PDRN) operating as a central technology service that programs and delivers content to edge devices through relationships with cellular carriers and consumer electronics manufacturers. The PDRN enables companies that do not traditionally service mass audiences to develop revenue based on widely distributed products by turning the manufacturing brand into an entertainment “station.” The proposed technological integration of a broadcast network with edge devices represents more than the organizational combination of product groups under common management. Because it provides for individual interactivity, the PDRN bonds with consumers in a manner that one-to-many broadcast models cannot match. Furthermore, devices integrated with the PDRN will differentiate more effectively than those that receive non-individualized broadcasts because of the enhanced bond between network provider and consumer.

For example, if a traditional television manufacturer buys a traditional television network, neither company gains an advantage over its competitors. It is not possible for the broadcaster to deliver programming only to televisions manufactured by its sibling, nor is it possible for the manufacturer to develop enhancements geared toward those watching its sibling's broadcasts. Consequently, there is no incentive for either to work together to enhance overall revenues. The PDRN, however, can deliver specialized programming to devices modified for specialized tastes.

Organizationally, the PDRN fills a role similar to that of a traditional broadcaster by providing content programming and advertising sales expertise. At the same time, it provides manufacturing expertise in the form of software development and Internet services. Because the PDRN delivers its “signal” through devices integrated with its software and Internet services at the operating system level, it has a strong market incentive to work with the device manufacturer to move product off the shelf. The quality of its entertainment programming will enhance the ability of the manufacturer to sell PDRN-enabled devices. As more consumers buy the integrated device, the PDRN's audience increases, increasing advertising revenues. The PDRN therefore has a strong market incentive to improve its content offerings to device consumers. In contrast to the traditional manufacturer buying a traditional broadcaster, the PDRN will be motivated to enhance the value of the combined undertaking by more than just common organizational control.

### BRIEF DESCRIPTION OF DRAWINGS

FIG. 1 is an architectural diagram illustrating a Personal Digital Radio Network (PDRN), according to an embodiment of the present invention.

FIG. 2 is a flow diagram illustrating a method for transferring content from a server to a PC, according to an embodiment of the present invention.

FIG. 3 is a flow diagram illustrating a method for transferring content from a server to a kiosk, according to an embodiment of the present invention.

FIG. 4 is a flow diagram illustrating a method for populating a portable device cache by a PC, according to an embodiment of the present invention.

FIG. 5 is a flow diagram illustrating a method for populating a portable device cache by a kiosk, according to an embodiment of the present invention.

FIG. 6 is flow diagram illustrating a method for playing back personal digital radio content on a portable device, according to an embodiment of the present invention.

FIG. 7 is a diagram illustrating an example session status table, according to one embodiment of the present invention.

FIG. 8 is a diagram illustrating an example playlist table, according to an embodiment of the present invention.

FIG. 9 is a diagram showing a sample content identification table, according to an embodiment of the present invention.

### DETAILED DESCRIPTION

The Personal Digital Radio Network (PDRN) operates over a combination of Internet and wireless networks, delivering content to “network edge” devices for playback that is asynchronous with receipt. The PDRN uses a caching model to facilitate delivery. Content is stored in a central data warehouse 101. Under the guidance of a database application 102 (hereinafter also referred to as a server), the content is broken into constituent data fields that can no longer be directly accessed by consumers, and is pushed as a “blob” over a network (such as the Internet or other network comprising wire and/or optical fiber) to a cache on personal computers and kiosks. From there, the content will be pushed to portable devices.

The PDRN pushes all content that it will program to all connected caches. Every listener therefore has the same disassembled content in their “blobs.” However, the server maintains a separate playlist for each listener (i.e. for each portable device), providing each with independent control over what content is selected for playback. Every connection to the central server receives a unique “session ID.” For portable devices, the unique identifier is a device identifier embedded into the hardware.

A portable client device does not generally know what content resides in its cached “blob.” Neither does it know what it is going to play. Instead, the portable device sends requests to the server over a cellular and/or wireless network. When a portable device first connects, it asks the server what should be played next from the portable device cache. This will typically be a greeting message. The message is a data file broken into constituent header and body fields that are identified by a unique alpha-numeric string. As described below, the string allows the device to assemble the header and body fields from data stored in its “blob” to play the audio content.

Once the playback of a piece of content ends, the device requests that server identify the next piece for playback, and so on. For pragmatic reasons, the server may download enough information for the portable device to play several pieces of content without asking. However, the “pure” operation of the network contemplates that the client will always ask, and in this way, the server remains aware of the playback behavior of the portable device.

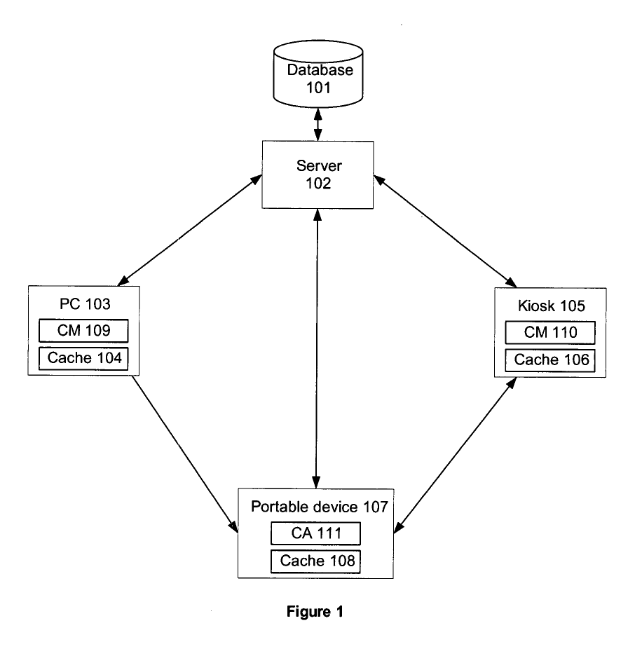

FIG. 1 is an architectural diagram illustrating a Personal Digital Radio Network (PDRN), according to an embodiment of the present invention. The PDRN comprises a data warehouse 101 for storing content. In a first embodiment, the content comprises audio content such as music files, advertisement, jingles and/or announcements, in an audio format such as MP3, AIFF or other format for storing and/or transferring audio content. Optionally, data warehouse 101 stores video content, text content, structured document content (e.g. expressed in XML, HTML or other markup language) and/or other content for delivery to a portable device. This content will be reduced to segmented data fields once transferred from the server to devices such as personal computers, kiosks, or mobile phones. As segmented data fields, the content is no longer stored in a usable file format. It must be reassembled as discussed below before users will perceive the content as an audio or video image.

A server 102 couples to data warehouse 101 and selectively sends content from data warehouse 101 to a personal computer (PC) 103 and/or to a kiosk 105 over a network. Server 101 sends a content aggregate (hereinafter “blob”) to PC 103 and/or to kiosk 105, the blob comprising a set of one or more audio files. Software on the PC or kiosk is responsible for disassembling the content into constituent header and body fields within the “blob.” PC 103 comprises a PC cache 104 for storing a blob received from the server 102, and Kiosk 105 comprises a kiosk cache 106 for storing a blob received from the server 102.

A portable device 107 connects (as described below) to a PC 103 and/or with a kiosk 106 for receiving the blob. Portable device 107 is a cellular phone, a portable audio player, a personal digital assistant (PDA) or other portable device for receiving content and for playing back received content to a user of the portable device 107. Portable device 107 stores the blob received from PC 103 and/or from kiosk 105 in a cache 106. A user of portable device 107 may choose, based on availability, convenience, device configuration, location and/or other parameters whether to receive a blob by connecting portable device 107 to a PC 103 or with a kiosk 105.

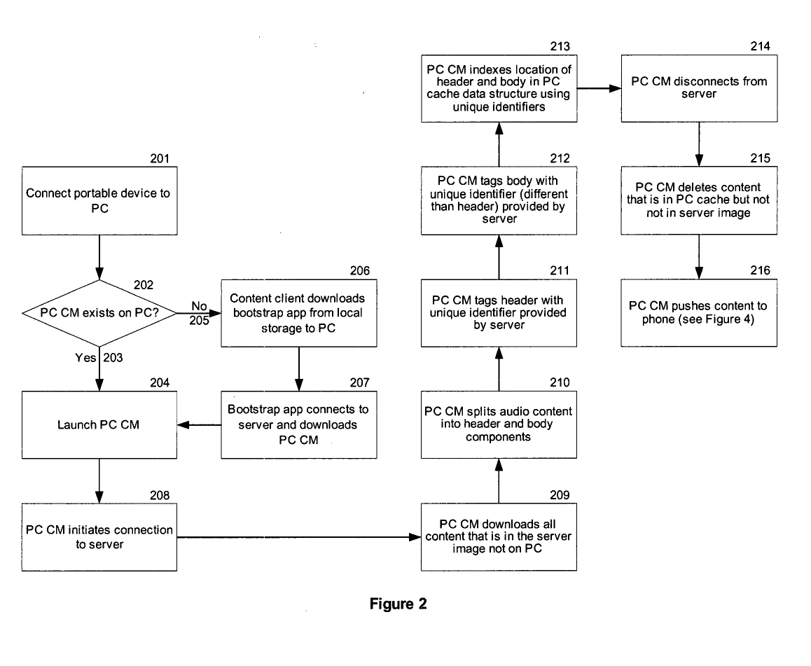

FIG. 2 is a flow diagram illustrating a method for transferring content from server 102 to PC 103, according to an embodiment of the present invention. A user connects 201 portable device 107 to PC 103. Portable device 107 determines 202 whether a PC content manager (hereinafter “PC CM”) 109 application resides on PC 103. If yes 203, portable device 107 causes the PC CM 109 to launch 204. Otherwise 205, portable device 107 transfers 206 a bootstrap application from the portable device 107 to the PC 103, the bootstrap application connects 207 to server 102 and downloads software implementing a PC CM 109 to the PC 103, and the PC CM 109 launches 204. Once launched, the PC CM 109 initiates 208 a connection to server 102 and downloads 209 content from the server 102. Server 102 maintains an updated blob and the PC CM 109 downloads portions of the server's 102 blob which are not yet available in the PC cache 104. PC CM 109 then divides 210 received audio content into header and body components, with each received audio clip divided into a corresponding header component and a corresponding body component. PC CM 109 tags 211 each header component with a unique header identifier and tags 212 each body component with a unique body identifier. The header and body identifiers are supplied by server 102 to PC CM 109, preferably during the download step 209. PC CM 109 then indexes 213 the locations of the header and body components in the PC cache 104 data structure using the corresponding unique header and body identifiers. PC CM 109 disconnects 214 from server 102 the deletes 215 content that resides in the PC cache 104 but does not reside in the updated blob of server 102 (i.e. deletes out-of-date content). PC CM 109 then pushes the up-to-date blob to the portable device 107 (described below).

In an alternative embodiment of the present invention, the PC CM 109 need not wait for a user to connect a portable device 107 to the PC 103 in order to initiate content download from server 102. Instead, PC CM 109 initiates a download of updated content from server 102, for example based on a recurring download schedule set by the server 102 and/or by a user of portable device 107. Upon a user's connecting portable device 107 to PC 103, the PC CM 109 pushes updated content to portable device 107, saving the user time otherwise spent waiting for the download to initiate and complete.

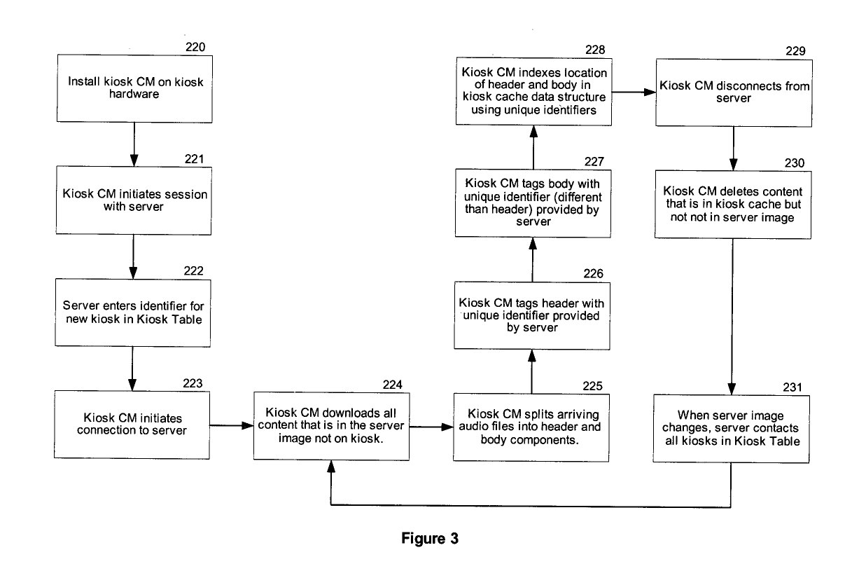

FIG. 3 is a flow diagram illustrating a method for transferring content from server 102 to kiosk 105, according to an embodiment of the present invention. Initially, an operator of kiosk 105 installs 220 a kiosk content manager (hereinafter “kiosk CM”) 110 application for communicating with the server 102 (analogous to the operation of PC CM 109). Server 102 preferably maintains a list of kiosks 106 which periodically requests content updates from the server 102. The installed kiosk CM 110 initiates 221 a communication session with server 102, and the server recognizes kiosk CM 110 as a fresh installation and adds 222 an identifier for the new kiosk 105 to the server's Kiosks Table. Steps 220-222 are performed upon an installation of kiosk CM 110 and need not be repeated in the future (except for example when re-installing or updating the kiosk CM 110 installation).

To obtain a content update from the server 102, kiosk CM 110 initiates 223 a connection to server 102 and downloads 224 content from the server 102. Similar to the above description of the PC CM 109, server 102 maintains an updated blob and the kiosk CM 110 downloads portions of the server's 102 blob which are not yet available in the kiosk cache 106. Kiosk CM 110 then divides 225 received audio content into header and body components, with each received audio clip divided into a corresponding header component and a corresponding body component. Kiosk CM 110 tags 226 each header component with a unique header identifier and tags 227 each body component with a unique body identifier. The header and body identifiers are supplied by server 102 to kiosk CM 110, preferably during the download step 224. Kiosk CM 110 then indexes 228 the locations of the header and body components in the kiosk cache 106 data structure using the corresponding unique header and body identifiers. Kiosk CM 110 disconnects 229 from server 102 the deletes 230 content that resides in the kiosk cache 106 but does not reside in the updated blob of server 102 (i.e. deletes out-of-date content). To keep the content in the kiosk cache 106 up-to-date with the content on server 102, server 102 contacts 231 kiosks 105 in server's 102 Kiosks Table whenever there is an update to the server's 102 content. This causes the kiosk CM 110 to download 224 the updated content and proceed with subsequent steps 225-230.

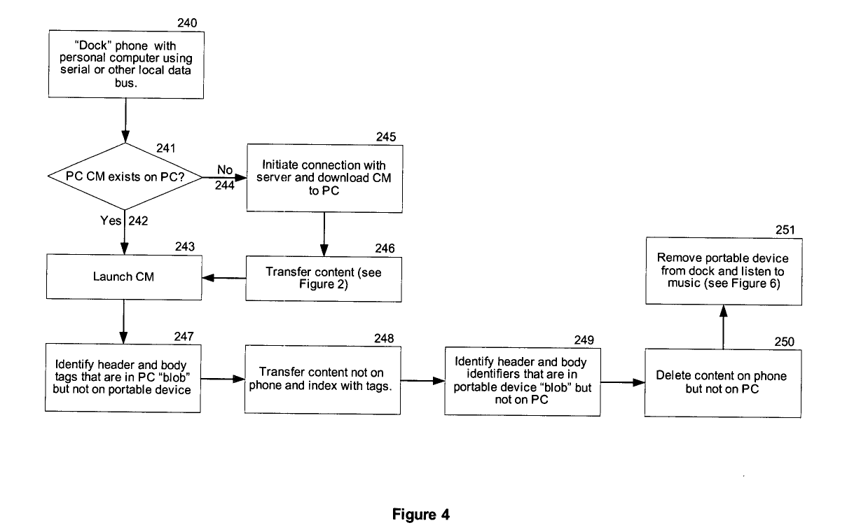

FIG. 4 is a flow diagram illustrating a method for populating portable device 107 cache 108 by PC 103, according to an embodiment of the present invention. A user connects 240 a portable device 107 to PC 103 using a serial bus (such as USB), other local bus, a wireless connection (such as using Bluetooth or 80211 protocol) or other connection from portable device 107 to PC 103. The connection may be initiated by “docking” the portable device 107 using a docking station or a cradle connected to PC 103. Portable device 107 comprises a client application 111 (hereinafter CA). The CA 111 determines 241 whether a PC CM 109 resides on PC 103. If yes 242, CA 111 causes PC CM 109 to launch 243. Otherwise 244, CA 111 initiates 245 a connection with server 102 and causes download of a PC CM 109 to PC 103. Once downloaded, PC CM 109 receives 246 a blob from server 102 for storage in the PC cache 104 (as described above in FIG. 2).

CA 111 identifies 247 header and body identifiers which reside in the PC 103 blob but do not reside in the portable device 107 blob (i.e. identifiers indicating new content), transfers 248 header and body components associated with such header and body identifiers from PC 103 to portable device 107, and indexes such transferred components with the corresponding identifiers. CA 111 then identifies 249 header and body identifiers which reside in the portable device 107 blob but do not reside in the PC 103 blob (i.e. identifiers indicating out-of-date content on the portable device 107) and deletes 250 such identifiers and corresponding header and body components residing in portable device 107 blob. The user may then disconnect 251 the portable device 107 from the PC 103 and proceed with audio content playback.

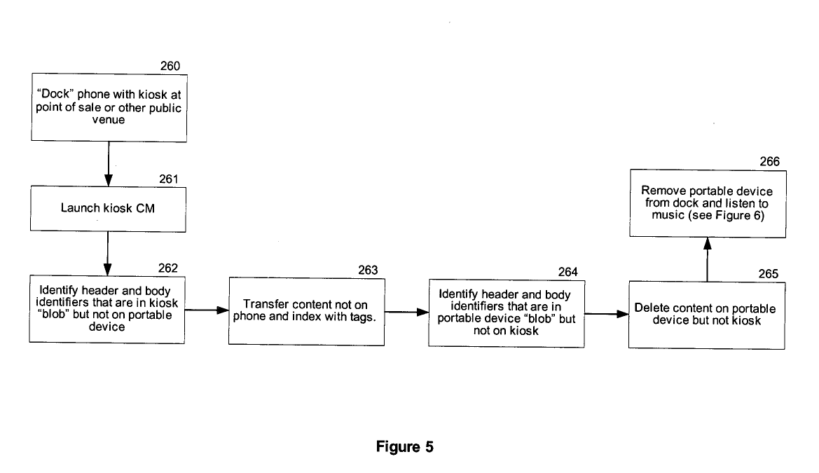

FIG. 5 is a flow diagram illustrating a method for populating portable device 107 cache 108 by kiosk 105, according to an embodiment of the present invention. A user connects 260 the portable device 107 to a kiosk 105 using a docking station, cradle and/or wired or wireless network connection. Kiosk 105 is located at portable device 107 point-of-sale, at a public venue and/or at any other location accessible to user. It is contemplated that kiosks 105 may be made available at train stations, shopping malls, airports, shops, restaurants and/or other locations accessible to users. Docking of portable device 107 causes the kiosk CM 110 to launch 261 (if kiosk CM 110 is not already running). Portable device 107 CA 111 identifies 262 header and body identifiers which reside in the kiosk 105 blob but do not reside in the portable device 107 blob (i.e. identifiers indicating new content), transfers 263 header and body components associated with such header and body identifiers from kiosk 103 to portable device 107, and indexes such transferred components with the corresponding identifiers. CA 111 then identifies 264 header and body identifiers which reside in the portable device 107 blob but do not reside in the kiosk 105 blob (i.e. identifiers indicating out-of-date content on the portable device 107) and deletes 265 such identifiers and corresponding header and body components residing in portable device 107 blob. The user may then disconnect 266 the portable device 107 from the kiosk 105 and proceed with audio content playback.

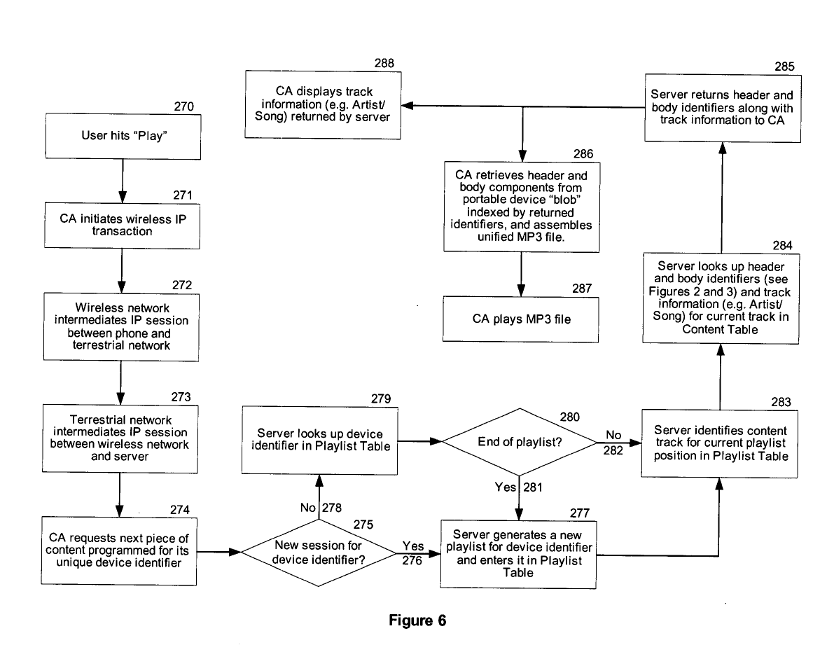

FIG. 6 is flow diagram illustrating a method for playing back personal digital radio content on a portable device 107, according to an embodiment of the present invention. User initiates playback of audio content on portable device 107, for example by pressing a “play” button on the portable device 107. Portable device 107 CA 111 initiates a network connection to server 102, for example by initiating 271 a wireless IP transaction, causing a wireless network to intermediate 272 an IP session between portable device 107 and a terrestrial network, the terrestrial network intermediating 273 an IP session between the wireless network and the server 102, thereby establishing a connection between portable device 107 and server 102. CA 111 then requests 274 the next piece of content programmed by server 102 for the portable device 107, wherein the portable device 107 identifies itself to the server 102 using a device identifier unique to the portable device 107, and wherein the server 102 maintains a content program for the portable device 107. Upon reception of the portable device 107 identifier, server 102 determines 275 whether this is a new session for the portable device 107. If yes 276, server 102 generates 277 a new playlist for the portable device 107 and records the playlist in a Playlist Table, the new playlist identified with the device identifier as lookup key. Otherwise 278 server 102 looks up the device identifier in the Playlist Table and determines the current playlist associated with the device identifier. If the playlist has reached 281 the end, server 102 proceeds to step 277, else server 102 continues to step 283.

In step 283, server 102 identifies the content track (audio clip) for the current playlist position in the Playlist Table, and uses a Content Table to look up 284 header and body identifiers as well as track information (e.g. Artist, Song name, Genre, Label, etc.) for the current track. Server 102 then returns 285 the header and body identifiers along with said track information to the portable device 107 CA 111. CA 111 uses the received header and body identifiers to index into the portable device 107 blob, to retrieve 286 the corresponding header and body components, and to assemble a full audio file (e.g. an MP3 file) comprising the retrieved header and body components. CA 111 then proceeds to playback 287 the assembled audio file for the user. In addition, CA 111 causes the portable device 107 to display the track information received from the server 102 for the audio which is being played back.

Following are descriptions of the various tables used to manage content playback. These include a table for session status, and a table that maintains playlists for the connected portable devices 107 (i.e. for the listeners). Because of the potential size of the playlist table, the delivery network will cluster users to manage scale, and will use mirroring and other database techniques to remove the need to have all portable devices 107 query the same instance of the data warehouse 101.

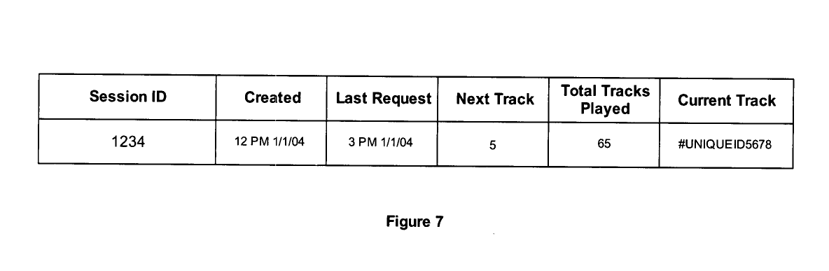

FIG. 7 is a diagram illustrating an example session status table, according to one embodiment of the present invention. The session status table comprises one record for every connected session. The record comprises such information as the time the session was created, the time of the last request, the playlist position number of the next track to be played, the total number of tracks requested during the session, and the unique key that identifies the track currently played.

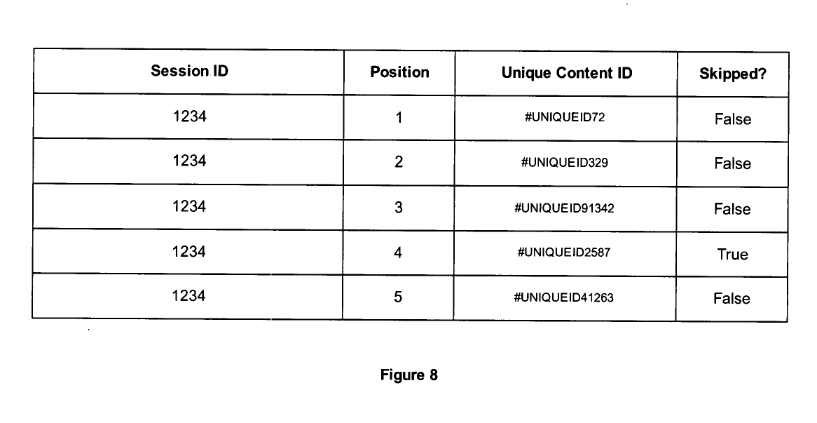

In addition to the session status table, the server 102 maintains a table that contains one record for every track programmed for a session, for all connected sessions. This record contains such information as the session ID, a value to indicate the row's order in that session's playlist, a unique identifier for the content track (e.g. song or advertisement) that is to be played at that position, and whether the track was skipped by the user (note that the user of portable device 107 may choose to skip a track during playback). FIG. 8 is a diagram illustrating an example playlist table, according to an embodiment of the present invention.

As described above, should the portable device 107 reach the end of the playlist, the server 102 generates a “new” list and the position resets to 1. Note that the session table maintains a count of the total number of tracks requested, which does not reset when the playlist regenerates.

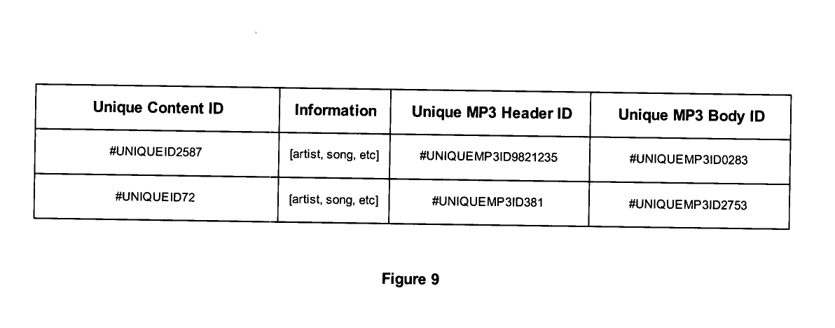

The unique content identifier is a key field that allows the relational database 101 to look up information about a piece of content (such as a song, advertisement, jingle, etc.) in a table containing a record for the pieces of content known to the system. Such a record identifies such information as the artist, song, album, genre, label, etc. This record is also used for the PDRN's digital rights management. As described above, a content file (such as an MP3 file) comprises a header component and a body component, and file cannot be played without both components identified and present. These components pieces are separated in the content “blobs” stored on PCs 103, kiosks 105 and portable devices 107, and the information needed to assemble the components into a unified file are stored in the content identification table. FIG. 9 is a diagram showing a sample content identification table, according to an embodiment of the present invention.

The header and body identifiers act as file names within the blob. The portable device 107 reassembles the MP3 file only “just in time” for playback. Because the information needed for reassembly is maintained on the server 102, it will be difficult for “pirates” to get content out of the blob. This architecture allows the PDRN to protect data more effectively than even a very robust encryption scheme, for example as used on DVDs (Digital Video Discs), because in the encryption case everything needed for playback is in the possession of the potential cracker. An additional advantage of the server-based system is that the unique identifiers can be regenerated at arbitrary times. Someone who deciphered a given blob would then have to decipher it all over again the next time.

Although MP3 headers may comprise artist and song names, the PDRN preferably does not make use of such fields Instead, the PDRN maintains such information in the content record. When a portable device 107 needs to display information about the content being played, the device requests the information from the server 102. Consequently, a pirate would be required to not only decipher the blob, but to listen to each track in order to identify it. This represents an enormous burden in the case of content stored at broadcast quality encoding (e.g. 48 kbs stereo). The file sharing services will typically store content at least at 128 kbs.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

1. A method for processing digital audio content, comprising the steps of:
receiving an audio file, a header identifier and a body identifier from a server; and
dividing the audio file into a header component and a body component;
the header identifier for associating with the header component, and the body identifier for associating with the body component.

2. The method of claim 1, further comprising sending the header component and the body component to a portable device for playback.

3. The method of claim 1, further comprising sending the header identifier and the body identifier to the portable device.

4. A method for processing digital audio content, comprising the steps of:
receiving a header identifier and a body identifier;
retrieving a header component and a body component from a local cache, the header identifier serving as a lookup key for retrieving the header component, the body identifier serving as a lookup key for retrieving the body component; and
assembling the header component and the body component into an audio file for playback.

5. The method of claim 4, wherein the audio file comprises an MP3 file.

6. The method of claim 4, wherein the header identifier and the body identifier are supplied by a server, the receiving step comprising communicating with the server via a network.

7. The method of claim 6, wherein the network comprises a cellular network.

8. A method for providing digital audio content, comprising the steps of:
receiving a portable device identifier from a portable device;
retrieving a playlist from a database using the portable device identifier as a lookup key, the playlist indicating a content identifier, the content identifier identifying an audio track for playback by the portable device; and
sending a header identifier and a body identifier to the portable device, the header identifier and the body identifier indicated by the content identifier;
wherein the header identifier indicates a header component residing on the portable device, the body identifier indicates a body component residing on the portable device, and assembling the header component and the body component produces an audio file for playback by the portable device.

9. The method of claim 8, wherein the audio file comprises an MP3 file.

10. A method for processing digital audio content, comprising the steps of:
receiving a first set of audio content identifiers from a server, the first set of audio content identifiers indicating a first set of audio files residing on the server;
comparing the first set of audio content identifiers to a second set of audio content identifiers, the second set of audio content identifiers indicating a second set of audio files residing in a local cache;
downloading audio content indicated by the first set of audio content identifiers as residing on the server and indicated by the second set of audio content identifiers as missing from the local cache; and
deleting audio content indicated by the second set of audio content identifiers as residing in the local cache and indicated by the first set of audio content identifiers as missing from the server.

11. The method of claim 10, wherein the audio content comprises one or more MP3 files.

12. The method of claim 10, wherein a user initiates the receiving step by docking a portable device at a docking station.

13. The method of claim 10, wherein the receiving step is performed periodically according to a user-defined schedule.

14. The method of claim 10, wherein he receiving step is performed periodically according to a server-defined schedule.
